(19) United States
(12) Patent Application Publication
(10) Pub. No.: US 2023/0030143 A1
(43) Pub. Date: Feb. 2, 2023

(54) COLLABORATIVE AGGREGATION TRADING METHOD FOR CONSUMING CLEAN ENERGY THROUGH DEMAND-SIDE RESOURCES AND SHARED ENERGY STORAGE

(71) Applicants: Beijing Electric Power Trading Center Co., Ltd, Beijing (CN); North China Electric Power University, Beijing (CN)

(72) Inventors: Li SONG, Beijing (CN); Dunnan LIU, Beijing (CN); Zhu LI, Beijing (CN); Shengnan ZHANG, Beijing (CN); Bo PANG, Beijing (CN); Ningning ZHAO, Beijing (CN); Tian SUN, Beijing (CN); Haiyan YANG, Beijing (CN); Xiaofeng XU, Beijing (CN)

(21) Appl. No.: 17/862,331

(22) Filed: Jul. 11, 2022

(30) Foreign Application Priority Data
Jul. 13, 2021 (CN) 202110789079.0

(51) Int. Cl. H02J 3/00; H02J 3/38; G06Q 50/06

(52) U.S. Cl. CPC H02J 3/008; H02J 3/004; H02J 3/381; G06Q 50/06

(57) ABSTRACT

A collaborative aggregation trading method for consuming clean energy includes: acquiring related data of clean energy power generation companies, the demand-side resources and energy storage service providers; acquiring a trading quotation and acquiring self-regulating ability data and regulating fees of shared energy storage service providers; performing trading of collaboratively consuming the clean energy through the demand-side resources and the shared energy storage: when the power generation output value exceeds the maximum regulating ability of user demands and the demand-side resources, storing the redundant power into shared energy storage systems for standby application; when the power generation output value is lower than the minimum operation load level of the user demands and the demand-side resources, calling the shared energy storage service providers participating in the trading according to energy storage ranking indexes, to acquire required power from the shared energy storage systems; and performing fees settlement.

### CROSS REFERENCE TO RELATED APPLICATIONS

This application claims foreign priority of Chinese Patent Application No. 202110789079.0, filed on Jul. 13, 2021 in the China National Intellectual Property Administration, the disclosures of all of which are hereby incorporated by reference.

### TECHNICAL FIELD

The present invention relates to the technical field of power economics, and particularly relates to a collaborative aggregation trading method for consuming clean energy through demand-side resources and shared energy storage.

### BACKGROUND OF THE PRESENT INVENTION

High-efficient development and utilization of clean energy is a significant strategic measure of realizing ‘carbon peaking and carbon neutrality’. However, since new energy power generation has intermittency and randomness, energy storage is limited by conditions, such as regulating characteristics, capacity and the like, so that complete consumption of the clean energy cannot be realized, and the phenomena of wind abandonment and light abandonment can still be caused; and therefore, high-efficiency utilization of the clean energy cannot be realized.

The discovery of the regulating ability of demand-side resources enables a thought of electric energy balance to be transformed from ‘resources are changed along with loads’ into ‘loads are changed along with resources’ and also enables market designers to see the consumption potential of the clean energy of the demand-side resources. However, since an effective market mechanism is lacked, demand-side response resources of users do not have a reasonable channel to participate in the market, thereby limiting the realization of the potential of tracking and consuming the clean energy.

Therefore, it is necessary to research a collaborative aggregation trading method for consuming clean energy through demand-side resources and shared energy storage, which can utilize energy storage and the demand-side resources to jointly consume the clean energy and can fully tap the consumption potential of the demand-side resources.

### SUMMARY OF PRESENT INVENTION

The present invention aims to design a collaborative aggregation trading method for consuming clean energy through demand-side resources and shared energy storage, which can utilize energy storage and the demand-side resources to jointly consume the clean energy and can fully tap the consumption potential of the demand-side resources.

The collaborative aggregation trading method for consuming the clean energy through the demand-side resources and the shared energy storage, which is provided by the present invention, comprises the following steps:

acquiring related data of clean energy power generation companies, the demand-side resources and energy storage service providers, wherein the related data comprises prediction curves of power generation of the clean energy power generation companies, prediction curves of loads of the demand-side resources, as well as regulating ability data and service fee data of the energy storage service providers;

acquiring a trading quotation which is negotiated by the clean energy power generation companies and demand-side users and acquiring self-regulating ability data and regulating fees of shared energy storage service providers;

carrying out trading of collaboratively consuming the clean energy through the demand-side resources and the shared energy storage: when the power generation output value exceeds the maximum regulating ability of user demands and the demand-side resources, storing the redundant power into shared energy storage systems for standby application; and when the power generation output value is lower than the minimum operation load level of the user demands and the demand-side resources, calling the shared energy storage service providers participating in the trading according to energy storage ranking indexes, to acquire required power from the shared energy storage systems;

carrying out fees settlement on the trading to respectively acquire total income of the clean energy power generation companies, total income of the energy storage service providers and total income of the demand-side users.

Further, the energy storage ranking index is:

$${RANK}_{{SS}_{n}}^{j} = \frac{{Vol}_{{SS}_{n}}^{j} * {res}_{{SS}_{n}}^{t - 1}}{{P}_{{SS}_{n}}^{j}} \times RANK ( {T}_{{SS}_{n}}^{j} )$$

wherein RANK_{SS}_{ₙ}^{j} represents a ranking index of an energy storage service provider SSₙ in a j^{th} quotation, and Vol_{SS}_{ₙ}^{j} represents the regulating ability thereof; res_{SS}_{ₙ}^{t-1}, represents a historical response level, and the performance of the historical level of the energy storage service provider is comprehensively scored to obtain the value of [0, 1]; P_{SS}_{ₙ}^{j} represents the service price thereof; and RANK (T_{SS}_{ₙ}^{j}) represents the ranking of declaration time. ‘x’ represents a computational logic: when in clearing, the proportions of capacities, prices and historical response levels of declaration subjects are firstly calculated, to obtain comprehensive indexes of economy and applicability thereof. The internal logic of the indexes is that: under the condition of the same regulating ability, the lower the price is, the higher a comprehensive index coefficient is, and the higher the ranking is; and under the condition of the same price, the greater the regulating ability is, the higher the comprehensive index coefficient is, and the higher the ranking is. If the comprehensive indexes of two declaration subjects are the same, according to the ranking of the declaration time, the earlier the time is, the higher the ranking is.

Further, a method of carrying out fees settlement on the trading to respectively obtain the total income of the clean energy power generation companies, the total income of the energy storage service providers and the total income of the demand-side users is that: net income of the clean energy power generation companies is the power generation income, from which energy storage service fees are deducted; net income of the energy storage service providers is the sum of capacity fee income and kilowatt-hour fee income; and the power utilization cost of the demand-side users is the sum of consumption fees of various types of clean energy, and the income thereof is the saved power utilization cost after the demand-side users participate in consumption.

Further, the energy storage service fees comprise a capacity fee and a kilowatt-hour fee; the capacity fee is used for compensating the opportunity cost generated as the energy storage systems participate in regulation, and the kilowatt-hour fee is used for compensating the loss generated as the energy storage systems are used; and the energy storage service fees are borne jointly by the clean energy power generation companies and the demand-side users.

Further, a method of acquiring the consumed power of various types of clean energy of the demand-side users comprises: decomposing the consumed power of various types of clean energy according to supply states of a power system, such as the total power consumption and power utilization moments of each user, after an overall optimization result of the system is obtained, to obtain the total consumed power of photovoltaic power generation and the total consumed power of wind power generation of the demand-side users.

Specifically, the decomposition of the consumed power is a subsequent important settlement basis of each user; and the consumed power is decomposed according to the supply states of the power system, such as the total power consumption and the power utilization moments of each user, after the overall optimization result of the system is obtained. When the power is decomposed, the time t can be divided into 24 periods, and the calculation formulas of the power generation proportion of various types of clean energy at an initial moment (t=1) in the power system are shown as follows:

$${e}_{solar}^{t = 1} = \frac{{E}_{solar}^{t = 1}}{{E}_{Total}^{t = 1}}$$

$${e}_{wind}^{t = 1} = \frac{{E}_{wind}^{t = 1}}{{E}_{Total}^{t = 1}}$$

wherein in the formulas, eₛₒₗₐᵣ^{t=1} represents the proportion of the photovoltaic power generation at the initial moment, Eₛₒₗₐᵣ^{t=1} represents the output of the photovoltaic power generation of the system at the initial moment, and E_{Total}^{t=1} represents the total power generation capacity of the system at the initial moment; and similarly, e_{wind}^{t=1} represents the proportion of the wind power generation, E_{wind}^{t=1} represents the output of the wind power generation of the system at the initial moment, and it can be known from E_{Total}^{t=1}=Eₛₒₗₐᵣ^{t=1}+E_{wind}^{t=1} (t=1) that: eₛₒₗₐᵣ^{t=1}+_{wind}^{t=1}=1.

Next, the power utilization structure of each user needs to be primarily distributed according to the proportion values of the photovoltaic power generation and the wind power generation at the initial moment:

Eᵤ₍ₙ₎₋ₛₒₗₐᵣ^{t=1}=Eᵤ₍ₙ₎₋ₜₒₜₐₗ^{t=1}*eₛₒₗₐᵣ^{t=1}

E_{u(n)-wind}^{t=1}=Eᵤ₍ₙ₎₋ₜₒₜₐₗ^{t=1}*e_{wind}^{t=1}

and the above formulas respectively represent the consumed power of the photovoltaic power generation and the consumed power of the wind power generation, which are primarily distributed to a user u(n); and

then, the remaining power of the photovoltaic power generation and the remaining power of the wind power generation, which are stored in the system at the initial moment, need to be calculated, and the remaining power is obtained by deducting the power distributed to the user from the initial power generation capacity:

Eₙₛ₋ₛₒₗₐᵣ^{t=1}=Eₛₒₗₐᵣ^{t=1}−ΣEᵤ₍ₙ₎₋ₛₒₗₐᵣ^{t=1}

E_{ns-wind}^{t=1}=E_{wind}^{t=1}−ΣE_{u(n)-wind}^{t=1}

ΣEₙₛ₋ₛₒₗₐᵣ^{t=1}=ΣEᵤ₍₁₎₋ₛₒₗₐᵣ^{t=1}+ΣEᵤ₍₂₎₋ₛₒₗₐᵣ^{t=1}+ . . . +ΣEᵤ₍ₙ₋₁₎₋ₛₒₗₐᵣ^{t=1}+Eᵤ₍ₙ₎₋ₛₒₗₐᵣ^{t=1}

ΣE_{u(n)-wind}^{t=1}=ΣE_{u(1)-wind}^{t=1}+ΣE_{u(2)-wind}^{t=1}+ . . . +ΣE_{u(n-1)-wind}^{t=1}+E_{u(n)-wind}^{t=1}

In the formulas, Eₙₛ₋ₛₒₗₐᵣ ^{t=1} represents the stored power of the photovoltaic power generation of the system at the initial moment, and ΣEᵤ₍ₙ₎₋ₛₒₗₐᵣ ^{t=1} represents the total consumed power of the photovoltaic power generation, which is distributed to the user at the initial moment; and E_{ns-wind} ^{t=1} represents the stored power of the wind power generation of the system at the initial moment, and ΣE_{u(n)-wind} ^{t=1} represents the total consumed power of the wind power generation, which is distributed to the user at the initial moment.

The proportion of the power generation structure of the system at a moment t=2 is calculated; and the total power generation supply of the system at the moment t=2 comprises the newly added total power generation capacity and the total stored power which is accumulated by the system at the last moment. The photovoltaic power generation comprises the newly added output of the photovoltaic power generation of the system and the total stored power of the photovoltaic power generation of the system at the last moment; and the wind power generation comprises the newly added output of the wind power generation of the system and the total stored power of the wind power generation of the system at the last moment, meeting the formulas below:

$${e}_{solar}^{t = 2} = \frac{{E}_{solar}^{t = 2} + {E}_{ns - solar}^{t = 1}}{{E}_{NEW}^{t = 2} + {E}_{STORAGE}^{t = 1}}$$

$${e}_{wind}^{t = 2} = \frac{{E}_{wind}^{t = 2} + {E}_{ns - wind}^{t = 1}}{{E}_{NEW}^{t = 2} + {E}_{STORAGE}^{t = 1}}$$

In the formulas, eₛₒₗₐᵣ^{t=2} represents the proportion of the photovoltaic power generation at the moment t=2; Eₛₒₗₐᵣ^{t=2} represents the output of the photovoltaic power generation of the system at the moment t=2; Eₙₛ₋ₛₒₗₐᵣ^{t=1} represents the total power of the photovoltaic power generation, which is stored by the system at the moment t=1; E_{NEW} ^{t=2} represents the total newly added output of the power generation of the system at the moment t=2; and E_{STORAGE} ^{t=1} represents the total stored power of the system at the moment t=1. Similarly, e_{wind} ^{t=2} represents the proportion of the wind power generation at the moment t=2, E_{wind} ^{t=2} represents the output of the wind power generation of the system at the moment t=2, and E_{ns-wind} ^{t=1} represents the total power of the wind power generation, which is stored by the system at the moment t=1. E_{NEW}^{t=2}, Eₛₒₗₐᵣ ^{t=2} and E_{wind} ^{t=2} have the following relationship:

E_{NEW}^{t=2}=Eₛₒₗₐᵣ ^{t=2}+E_{wind} ^{t=2}

E_{STORAGE}^{t=1}=Eₙₛ₋ₛₒₗₐᵣ ^{t=1} and E_{ns-wind} ^{t=1 have the following relationship:}

E_{STORAGE}^{t=1}=Eₙₛ₋ₛₒₗₐᵣ ^{t=1}+E_{ns-wind} ^{t=1}

The allocation of the power utilization structure of each user at the moment t=2 is calculated, which is the product of the total power consumption of the user and the corresponding proportion value of the power generation, following the formulas below:

Eᵤ₍ₙ₎₋ₛₒₗₐᵣ^{t=2}=Eᵤ₍ₙ₎₋ₜₒₜₐₗ^{t=2}*eₛₒₗₐᵣ^{t=2}

E_{u(n)-wind}^{t=2}=Eᵤ₍ₙ₎₋ₜₒₜₐₗ^{t=2}*e_{wind}^{t=2}

wherein in the formulas, Eᵤ₍ₙ₎₋ₛₒₗₐᵣ^{t=2} represents the consumed power of the photovoltaic power generation, which is distributed to the user u(n) at the moment t=2, E_{u(n)-wind} ^{t=2} represents the consumed power of the wind power generation, which is distributed to the user at the moment t=2, and Eᵤ₍ₙ₎₋ₜₒₜₐₗ^{t=2} represents the total power consumption of the user u(n) at the moment t=2.

The newly added stored power of the photovoltaic power generation and the newly added stored power of the wind power generation of the system at the moment t=2 are calculated: the stored power of the photovoltaic power generation is obtained by deducting the consumed power of the photovoltaic power generation, which is distributed to the user, from the total power of the photovoltaic power generation of the system at the moment t=2; and the stored power of the wind power generation is obtained by deducting the consumed power of the wind power generation, which is distributed to the user, from the total power of the wind power generation of the system at the moment t=2, following the formulas below:

Eₙₛ₋ₛₒₗₐᵣ^{t=2}=(Eₛₒₗₐᵣ^{t=2}+Eₙₛ₋ₛₒₗₐᵣ ^{t=1})−ΣEᵤ₍ₙ₎₋ₛₒₗₐᵣ^{t=2}

E_{ns-wind}^{t=2}=(E_{wind}^{t=2}+E_{ns-wind} ^{t=1})−ΣE_{u(n)-wind}^{t=1}

ΣEₙₛ₋ₛₒₗₐᵣ^{t=2}=Eᵤ₍₁₎₋ₛₒₗₐᵣ^{t=2}+Eᵤ₍₂₎₋ₛₒₗₐᵣ^{t=2}+ . . . +Eᵤ₍ₙ₋₁₎₋ₛₒₗₐᵣ^{t=2}+Eᵤ₍ₙ₎₋ₛₒₗₐᵣ^{t=2}

ΣE_{u(n)-wind}^{t=2}=E_{u(1)-wind}^{t=2}+E_{u(2)-wind}^{t=2}+ . . . +E_{u(n-1)-wind}^{t=2}+E_{u(n)-wind}^{t=2}

wherein in the formulas, Eₛₒₗₐᵣ^{t=2} represents the stored power of the t=2 photovoltaic power generation of the system at the moment t=2; ΣEᵤ₍ₙ₎₋ₛₒₗₐᵣ^{t=2} represents the total consumed power of the photovoltaic power generation of the system, which is distributed to the user at the moment t=2; E_{ns-wind}^{t=2} represents the stored power of the wind power generation of the system at the moment t=2; and ΣE_{u(n)-wind}^{t=2} represents the total consumed power of the wind power generation, which is distributed to the user at the moment t=2.

The above steps are repeated, corresponding data of moments t=3, t=4, . . . , t=23 and t=24 are sequentially calculated, and the total consumed power of the photovoltaic power generation and the total consumed power of the wind power generation of the user are calculated. The total consumed power of the photovoltaic power generation is obtained by summating the distributed consumed power of the photovoltaic power generation of the user at all the moments; and the total consumed power of the wind power generation is obtained by summating the distributed consumed power of the wind power generation of the user at all the moments, following the formulas below:

$$\sum {E}_{u ( n ) - solar} = {\sum }_{i = 1}^{24} {E}_{u ( n ) - solar}$$

$$\sum {E}_{u ( n ) - wind} = {\sum }_{i = 1}^{24} {E}_{u ( n ) - wind}$$

In the formulas, ΣEᵤ₍ₙ₎₋ₛₒₗₐᵣ represents the total consumed power of the photovoltaic power generation of the user u(n), and ΣE_{u(n)-wind} represents the total consumed power of the wind power generation of the user u(n).

Further, a method of acquiring the kilowatt-hour fee comprises:

acquiring a variable output value of each called energy storage service provider at each moment and obtaining the total kilowatt-hour fee of each moment; and

allocating the kilowatt-hour fee of each moment between each clean energy power generation company and the user: wherein when the energy storage system is charged, the kilowatt-hour fee is borne by the clean energy power generation company; when the energy storage system is discharged, the kilowatt-hour fee is borne by the user; the kilowatt-hour fee of the clean energy power generation company is allocated according to the storage proportion; and the kilowatt-hour fee of the user is allocated according to the proportion of the total power consumption of all the moments in the power consumption of all the users.

Further, a method of acquiring the output value of each called energy storage service provider at each moment comprises:

1) judging whether E_{STORAGE}^{t=1}>R_{VOL}¹ is true or not, wherein E_{STORAGE}^{t=1} represents the energy storage demand of the system at the moment t=1, and R_{VOL}¹ represents the capacity of the system of a called energy storage service provider No. 1;

a, if yes, systems of the remaining energy storage service providers need to be called continuously;

b, if no, remaining energy storage systems do not need to be called continuously;

2) acquiring an actual load state of the called energy storage service provider No. 1:

a, if 1) is true, E₁^{t=1} R_{VOL}¹ i.e., the actual load of a called energy storage system No. 1 is the capacity thereof at the moment t=1, and namely, the system operates at full load;

b, if 1) is not true, E₁^{t=1}=E_{STORAGE}^{t=1} i.e., the actual load of the called energy storage system No. 1 is the energy storage demand of the system at the moment t=1, and namely, the system operates at a load of the energy storage demand;

3) acquiring the capacity of the system of the energy storage service provider, which needs to be called continuously at the moment t=1:

when 1) is true, the called energy storage system No. 1 operates at full load, which still cannot meet the energy storage demand of the system; the remaining energy storage systems need to be called continuously; and the capacity of the energy storage system which needs to be called continuously at the moment t=1 is:

E_{STORAGE}^{t=1}(−1)=E_{STORAGE}^{t=1}−R_{VOL}¹

in the formula, E_{STORAGE}^{t=1}(−1) represents the remaining demand after the energy storage system is called once at the moment t=1;

4) judging whether E_{STORAGE}^{t=1}(−1)>R_{VOL}² is true or not:

a, if yes, the remaining energy storage demand of the system at the moment t=1 is greater than the capacity of a called energy storage system No. 2, and the remaining energy storage systems need to be called continuously;

b, if no, the remaining energy storage demand of the system at the moment t=1 is less than the capacity of the called energy storage system No. 2, and the remaining energy storage systems do not need to be called continuously;

5) acquiring an actual load state of the called energy storage system No. 2, which is the same as step 2);

6) acquiring the capacity of the energy storage system which needs to be called again at the moment t=1, which is the same as step 3);

circulating the above steps until the output demand which meets energy storage of the system at the moment t=1 is obtained.

The present invention has the following advantages and positive effects that:

In the method, the demand-side resources are integrated with the characteristic of energy storage, so as to provide the maximum realization space for clean energy power generation, reduce the phenomena of wind abandonment and light abandonment to the greatest extent, promote the consumption of the clean energy and be beneficial for promotion of the realization of the goal of ‘carbon peaking and carbon neutrality’.

### DESCRIPTION OF THE DRAWINGS

FIG. 1 is a diagram of prediction curves of incremental power generation of clean energy provided in an embodiment of the present invention;

FIG. 2 is a diagram of prediction curves of loads of users provided in an embodiment of the present invention;

FIG. 3 is a diagram of load proportions of users provided in an embodiment of the present invention;

FIG. 4 is a diagram of optimized clearing results of systems provided in an embodiment of the present invention;

FIG. 5 is a diagram of decomposition results of photovoltaic power generation provided in an embodiment of the present invention;

FIG. 6 is a diagram of decomposition results of wind power generation provided in an embodiment of the present invention; and

FIG. 7 is a flow diagram of the collaborative aggregation trading method for consuming clean energy through demand-side resources and shared energy storage.

### DETAILED DESCRIPTION OF PREFERRED EMBODIMENTS

In order that the implementation purposes, the technical solutions and the advantages of the present invention are clearer, the technical solutions in embodiments of the present invention are described in detail below through combination with the drawings in the embodiments of the present invention. In the drawings, the same or similar mark numbers represent same or similar components or components with the same or similar functions all the time. The described embodiments are a part of embodiments of the present invention, rather than all embodiments. The embodiments described hereinafter with reference to the drawings are exemplary, are intended to explain the present invention and cannot be understood as the limit to the present invention. Based on the embodiments in the present invention, all other embodiments obtained by those ordinary skilled in the art without contributing creative work belong to the protection scope of the present invention.

According to a retail package pricing method with consideration of a price demand response, a demand response model is constructed; a cost-income function of electricity retailers, which comprises electricity retail income, electricity purchase expenditure and response income, is analyzed; and a retail package pricing model is constructed, thereby providing decision support for the retailers from the aspect of optimizing the pricing.

The embodiments of the present invention are described in details hereinafter through combination with the drawings.

A collaborative aggregation trading method for consuming clean energy through demand-side resources and shared energy storage, which is provided by the present invention, comprises the following steps:

acquiring related data of clean energy power generation companies, the demand-side resources and energy storage service providers, wherein the related data comprises prediction curves of power generation of the clean energy power generation companies, prediction curves of loads of the demand-side resources, as well as regulating ability data and service fee data of the energy storage service providers;

acquiring a trading quotation which is negotiated by the clean energy power generation companies and demand-side users and acquiring self-regulating ability data and regulating fees of shared energy storage service providers,

wherein it needs to be noted that after the clean energy power generation companies and the users with the regulating ability submit prediction curves of a next day, the prediction curves of power generation of the clean energy power generation companies and the prediction curves of the loads of the users are respectively superposed, and the overall condition of supply and demand of the market is published; the clean energy power generation companies and the users are organized to develop bilateral negotiated trading; in the bilateral negotiated trading, the clean energy power generation companies and the users make quotations according to the condition of supply and demand of the market; and the quotation of the clean energy power generation companies needs to follow the formula below:

P_{S}_{ₙ}=C_{S}_{ₙ}+G_{S}_{ₙ}+θ_{S}_{ₙ}

wherein P_{S}_{ₙ} represents a unit power supply quotation of a clean energy power generation company Sₙ; C_{S}_{ₙ} represents the unit power generation cost of Sₙ; G_{S}_{ₙ} represents the predicted green value premium of the unit power of Sₙ; θ_{S}_{ₙ} represents the predicted premium of the market condition at a trading period; and for the clean energy power generation company, the expectation thereof is that the total income after the clean energy power generation company participates in market trading is not less than the sum of the power generation cost and the reasonable profit;

the quotation of the users follows the formula bellow:

P_{D}_{ₙ}=C_{D}_{ₙ}+G_{D}_{ₙ}+O_{D}_{ₙ}

wherein P_{D}_{ₙ} represents a unit power utilization quotation of a user Dₙ; C_{D}_{ₙ} represents a tariff of Dₙ; G_{D}_{ₙ} represents the unit cost that Dₙ completes the quota index of the clean energy; θ_{D}_{ₙ} represents the predicted premium of the market condition at a trading period; and for the user, the expectation thereof is that the total power cost after the user participates in the market trading is not greater than the sum of the original tariff and the cost of completing the quota index of renewable energy sources;

carrying out trading of collaboratively consuming the clean energy through the demand-side resources and the shared energy storage: when the power generation output value exceeds the maximum regulating ability of user demands and the demand-side resources, storing the redundant power into shared energy storage systems for standby application; and when the power generation output value is lower than the minimum operation load level of the user demands and the demand-side resources, calling the shared energy storage service providers participating in the trading according to energy storage ranking indexes, to acquire required power from the shared energy storage systems;

carrying out fees settlement on the trading to respectively acquire total income of the clean energy power generation companies, total income of the energy storage service providers and total income of the demand-side users.

Further, the energy storage ranking index is:

$${RANK}_{{SS}_{n}}^{j} = \frac{{Vol}_{{SS}_{n}}^{j} * {res}_{{SS}_{n}}^{t - 1}}{{P}_{{SS}_{n}}^{j}} \times RANK ( {T}_{{SS}_{n}}^{j} )$$

wherein RANK_{SS}_{ₙ}^{j} represents a ranking index of an energy storage service provider SSₙ in a j^{th} quotation, and Vol_{SS}_{ₙ}^{j} represents the regulating ability thereof; res_{SS}_{ₙ}^{t-1} represents a historical response level, and the performance of the historical level of the energy storage service provider is comprehensively scored to obtain the value of [0, 1]; P_{SS}_{ₙ}^{j} represents the service price thereof; and RANK (T_{SS}_{ₙ}^{j}) represents the ranking of declaration time. ‘x’ represents a computational logic: when in clearing, the proportions of capacities, prices and historical response levels of declaration subjects are firstly calculated, to obtain comprehensive indexes of economy and applicability thereof. The internal logic of the indexes is that: under the condition of the same regulating ability, the lower the price is, the higher a comprehensive index coefficient is, and the higher the ranking is; and under the condition of the same price, the greater the regulating ability is, the higher the comprehensive index coefficient is, and the higher the ranking is. If the comprehensive indexes of two declaration subjects are the same, according to the ranking of the declaration time, the earlier the time is, the higher the ranking is.

Further, a method of carrying out fees settlement on the trading to respectively obtain the total income of the clean energy power generation companies, the total income of the energy storage service providers and the total income of the demand-side users is that: net income of the clean energy power generation companies is power generation income, from which energy storage service fees are deducted; net income of the energy storage service providers is the sum of capacity fee income and kilowatt-hour fee income; and the power utilization cost of the demand-side users is the sum of consumption fees of various types of clean energy, and the income thereof is the saved power utilization cost after the demand-side users participate in consumption.

Further, the energy storage service fees comprise a capacity fee and a kilowatt-hour fee; the capacity fee is used for compensating the opportunity cost generated as the energy storage systems participate in regulation, and the kilowatt-hour fee is used for compensating the loss generated as the energy storage systems are used; and the energy storage service fees are borne jointly by the clean energy power generation companies and the demand-side users.

Further, a method of acquiring the consumed power of various types of clean energy of the demand-side users comprises: decomposing the consumed power of various types of clean energy according to supply states of a power system, such as the total power consumption and power utilization moments of each user, after an overall optimization result of the system is obtained, to obtain the total consumed power of photovoltaic power generation and the total consumed power of wind power generation of the demand-side users.

Specifically, the decomposition of the consumed power is a subsequent important settlement basis of each user; and the consumed power is decomposed according to the supply states of the power system, such as the total power consumption and the power utilization moments of each user, after the overall optimization result of the system is obtained. When the power is decomposed, the time t can be divided into 24 periods, and the calculation formulas of the power generation proportion of various types of clean energy at an initial moment (t=1) in the power system are shown as follows:

$${e}_{solar}^{t = 1} = \frac{{E}_{solar}^{t = 1}}{{E}_{Total}^{t = 1}}$$

$${e}_{wind}^{t = 1} = \frac{{E}_{wind}^{t = 1}}{{E}_{Total}^{t = 1}}$$

wherein in the formulas, eₛₒₗₐᵣ ^{t=1} represents the proportion of the photovoltaic power generation at the initial moment, Eₛₒₗₐᵣ^{t=1} represents the output of the photovoltaic power generation of the system at the initial moment, and E_{Total}^{t=1} represents the total power generation capacity of the system at the initial moment; and similarly, e_{wind}^{t=1} represents the proportion of the wind power generation, E_{wind}^{t=1} represents the output of the wind power generation of the system at the initial moment, and it can be known from E_{Total}^{t=1}=Eₛₒₗₐᵣ^{t=1}+E_{wind} ^{t=1} (t=1) that: eₛₒₗₐᵣ^{t=1}+e_{wind}^{t=1}=1

Next, the power utilization structure of each user needs to be primarily distributed according to the proportion values of the photovoltaic power generation and the wind power generation at the initial moment:

Eᵤ₍ₙ₎₋ₛₒₗₐᵣ^{t=1}=Eᵤ₍ₙ₎₋ₜₒₜₐₗ^{t=1}*eₛₒₗₐᵣ^{t=1}

E_{u(n)-wind}^{t=1}=Eᵤ₍ₙ₎₋ₜₒₜₐₗ^{t=1}*e_{wind}^{t=1}

the above formulas respectively represent the consumed power of the photovoltaic power generation and the consumed power of the wind power generation, which are primarily distributed to a user u(n);

then, the remaining power of the photovoltaic power generation and the remaining power of the wind power generation, which are stored in the system at the initial moment, need to be calculated, and the remaining power is obtained by deducting the power distributed to the user from the initial power generation capacity:

Eₙₛ₋ₛₒₗₐᵣ^{t=1}=(Eₛₒₗₐᵣ^{t=1}−ΣEᵤ₍ₙ₎₋ₛₒₗₐᵣ^{t=1}

E_{ns-wind}^{t=1}=(E_{wind}^{t=1}−ΣE_{u(n)-wind}^{t=1}

ΣE_{u(n)-wind}^{t=1}=ΣEᵤ₍₁₎₋ₛₒₗₐᵣ^{t=1}+ΣEᵤ₍₂₎₋ₛₒₗₐᵣ^{t=1}+ . . . +ΣEᵤ₍ₙ₋₁₎₋ₛₒₗₐᵣ^{t=1}+ΣEᵤ₍ₙ₎₋ₛₒₗₐᵣ^{t=1}

ΣE_{u(n)-wind}^{t=1}=ΣE_{u(1)-wind}^{t=1}+ΣE_{u(2)-wind}^{t=1}+ . . . +ΣE_{u(n-1)-wind}^{t=1}+ΣE_{u(n)-wind}^{t=1}

in the formulas, Eₙₛ₋ₛₒₗₐᵣ^{t=1} represents the stored power of the photovoltaic power generation of the system at the initial moment, and Eᵤ₍ₙ₎₋ₛₒₗₐᵣ^{t=1} represents the total consumed power of the photovoltaic power generation, which is distributed to the user at the initial moment; and E_{ns-wind}^{t=1} represents the stored power of the wind power generation of the system at the initial moment, and E_{u(n)-wind}^{t=1} represents the total consumed power of the wind power generation, which is distributed to the user at the initial moment.

The proportion of the power generation structure of the system at a moment t=2 is calculated; and the total power generation supply of the system at the moment t=2 comprises the newly added total power generation capacity and the total stored power which is accumulated by the system at the last moment. The photovoltaic power generation comprises the newly added output of the photovoltaic power generation of the system and the total stored power of the photovoltaic power generation of the system at the last moment; and the wind power generation comprises the newly added output of the wind power generation of the system and the total stored power of the wind power generation of the system at the last moment, meeting the formulas below:

$${e}_{solar}^{t = 2} = \frac{{E}_{solar}^{t = 2} + {E}_{ns - solar}^{t = 1}}{{E}_{NEW}^{t = 2} + {E}_{STORAGE}^{t = 1}}$$

$${e}_{wind}^{t = 2} = \frac{{E}_{wind}^{t = 2} + {E}_{ns - wind}^{t = 1}}{{E}_{NEW}^{t = 2} + {E}_{STORAGE}^{t = 1}}$$

in the formulas, eₛₒₗₐᵣ^{t=2} represents the proportion of the photovoltaic power generation at the moment t=2; Eₛₒₗₐᵣ ^{t=2} represents the total power of the generation of the system at the moment t=2; Eₙₛ₋ₛₒₗₐᵣ^{t=1} represents the total power of the photovoltaic power generation, which is stored by the system at the moment t=1; E_{NEW}^{t=2} represents the total newly added output of the power generation of the system at the moment t=2; and E_{STORAGE}^{t=1} represents the total stored power of the system at the moment t=1. Similarly, e_{wind}^{t=2} represents the proportion of the wind power generation at the moment t=2, E_{wind}^{t=1} represents the output of the wind power generation of the system at the moment t=2, and E_{ns-wind}^{t=1} represents the total power of the wind power generation, which is stored by the system at the moment t=1. E_{NEW}^{t=2}, Eₛₒₗₐᵣ^{t=2}, and E_{wind} ^{t=2} have the following relationship:

E_{NEW}^{t=2}=Eₛₒₗₐᵣ^{t=2}+E_{wind}^{t=2}

E_{STORAGE}^{t=1}=Eₛₒₗₐᵣ^{t=1}+E_{wind}^{t=}

E_{STORAGE}^{t=1}=Eₙₛ₋ₛₒₗₐᵣ^{t=1}+E_{ns-wind}^{t=1}

The allocation of the power utilization structure of each user at the moment t=2 is calculated, which is the product of the total power consumption of the user and the corresponding proportion value of the power generation, following the formulas below:

Eᵤ₍ₙ₎₋ₛₒₗₐᵣ^{t=2}=Eᵤ₍ₙ₎₋ₜₒₜₐₗ^{t=2}*eₛₒₗₐᵣ^{t=2}

E_{u(n)-wind}^{t=2}=Eᵤ₍ₙ₎₋ₜₒₜₐₗ^{t=2}*e_{wind}^{t=2}

in the formulas, Eᵤ₍ₙ₎₋ₛₒₗₐᵣ^{t=2} represents the consumed power of the photovoltaic power generation, which is distributed to the user u(n) at the moment t=2, E_{u(n)-wind}^{t=2} represents the consumed power of the wind power generation, which is distributed to the user at the moment t=2, and Eᵤ₍ₙ₎₋ₜₒₜₐₗ^{t=2} represents the total power consumption of the user u(n) at the moment t=2.

The newly added stored power of the photovoltaic power generation and the newly added stored power of the wind power generation of the system at the moment t=2 are calculated: the stored power of the photovoltaic power generation is obtained by deducting the consumed power of the photovoltaic power generation, which is distributed to the user, from the total power of the photovoltaic power generation of the system at the moment t=2; and the stored power of the wind power generation is obtained by deducting the consumed power of the wind power generation, which is distributed to the user, from the total power of the wind power generation of the system at the moment t=2, following the formulas below:

Eₙₛ₋ₛₒₗₐᵣ^{t=2}=(Eₛₒₗₐᵣ^{t=2}+Eₙₛ₋ₛₒₗₐᵣ ^{t=1})−ΣEᵤ₍ₙ₎₋ₛₒₗₐᵣ^{t=2}

E_{ns-wind}^{t=2}=(E_{wind}^{t=2}+E_{ns-wind} ^{t=1})−ΣE_{u(n)-wind}^{t=2}

ΣEₙₛ₋ₛₒₗₐᵣ^{t=2}=Eᵤ₍₁₎₋ₛₒₗₐᵣ^{t=2}+Eᵤ₍₂₎₋ₛₒₗₐᵣ^{t=2}+ . . . +Eᵤ₍ₙ₋₁₎₋ₛₒₗₐᵣ^{t=2}+Eᵤ₍ₙ₎₋ₛₒₗₐᵣ^{t=2}

ΣE_{u(n)-wind}^{t=2}=E_{u(1)-wind}^{t=2}+E_{u(2)-wind}^{t=2}+ . . . +E_{u(n-1)-wind}^{t=2}+E_{u(n)-wind}^{t=2}

wherein in the formulas, Eₙₛ₋ₛₒₗₐᵣ^{t=2} represents the stored power of the photovoltaic power generation of the system at the moment t=2; ΣEᵤ₍ₙ₎₋ₛₒₗₐᵣ^{t=2} represents the total consumed power of the photovoltaic power generation of the system, which is distributed to the user at the moment t=2; E_{ns-wind}^{t=2} represents the stored power of the wind power generation of the system at the moment t=2; and ΣE_{u(n)-wind}^{t=2} represents the total consumed power of the wind power generation, which is distributed to the user at the moment t=2.

The above steps are repeated, corresponding data of moments t=3, t=4, . . . , t=23 and t=24 are sequentially calculated, and the total consumed power of the photovoltaic power generation and the total consumed power of the wind power generation of the user are calculated. The total consumed power of the photovoltaic power generation is obtained by summating the distributed consumed power of the photovoltaic power generation of the user at all the moments; and the total consumed power of the wind power generation is obtained by summating the distributed consumed power of the wind power generation of the user at all the moments, following the formulas below:

$$\sum {E}_{u ( n ) - solar} = {\sum }_{i = 1}^{24} {E}_{u ( n ) - solar}$$

$$\sum {E}_{u ( n ) - wind} = {\sum }_{i = 1}^{24} {E}_{u ( n ) - wind}$$

in the formulas, ΣEᵤ₍ₙ₎₋ₛₒₗₐᵣ represents the total consumed power of the photovoltaic power generation of the user u(n), and ΣE_{u(n)-wind} represents the total consumed power of the wind power generation of the user u(n).

Further, a method of acquiring the kilowatt-hour fee comprises:

acquiring a variable output value of each called energy storage service provider at each moment and obtaining the total kilowatt-hour fee of each moment; and

allocating the kilowatt-hour fee of each moment between each clean energy power generation company and the user: wherein when the energy storage system is charged, the kilowatt-hour fee is borne by the clean energy power generation company; when the energy storage system is discharged, the kilowatt-hour fee is borne by the user; the kilowatt-hour fee of the clean energy power generation company is allocated according to the storage proportion; and the kilowatt-hour fee of the user is allocated according to the proportion of the total power consumption of all the moments in the power consumption of all the users.

Further, a method of acquiring the output value of each called energy storage service provider at each moment comprises:

1) judging whether the formula E_{STORAGE}^{t=1} 1>R_{VOL}¹ is true or not, wherein E_{STORAGE}^{t=1} represents the energy storage demand of the system at the moment t=1, and R_{VOL}¹, represents the capacity of the system of a called energy storage service provider No. 1;

a, if yes, systems of the remaining energy storage service providers need to be called continuously;

b, if no, remaining energy storage systems do not need to be called continuously;

2) acquiring an actual load state of the called energy storage service provider No. 1:

a, if 1) is true, E₁^{t=1} R_{VOL}^{t=1} i.e., the actual load of a called energy storage system No. 1 is the capacity thereof at the moment t=1, and namely, the system operates at full load;

b, if 1) is not true, E₁^{t=1}=E_{STORAGE}^{t=1} i.e., the actual load of the called energy storage system No. 1 is the energy storage demand of the system at the moment t=1, and namely, the system operates at a load of the energy storage demand;

3) acquiring the capacity of the system of the energy storage service provider, which needs to be called continuously at the moment t=1:

when 1) is true, the called energy storage system No. 1 operates at full load, which still cannot meet the energy storage demand of the system; the remaining energy storage systems need to be called continuously; and the capacity of the energy storage system which needs to be called continuously at the moment t=1 is:

E_{STORAGE}^{t=1}(−1)=E_{STORAGE}^{t=1}−R_{VOL}¹

in the formula, E_{STORAGE}^{t=1}(−1) represents the remaining demand after the energy storage system is called once at the moment t=1;

4) judging whether E_{STORAGE}^{t=1}(−1)>R_{VOL}² is true or not:

a, if yes, the remaining energy storage demand of the system at the moment t=1 is greater than the capacity of a called energy storage system No. 2, and the remaining energy storage systems need to be called continuously;

b, if no, the remaining energy storage demand of the system at the moment t=1 is less than the capacity of the called energy storage system No. 2, and the remaining energy storage systems do not need to be called continuously;

5) acquiring an actual load state of the called energy storage system No. 2, which is the same as step 2);

6) acquiring the capacity of the energy storage system which needs to be called again at the moment t=1, which is the same as step 3);

circulating the above steps until the output demand which meets energy storage of the system at the moment t=1 is obtained.

The output values of all the energy storage systems which are called sequentially at the moment t=1 are obtained finally, to obtain an output matrix:

E_{RANK}^{t=1}=[E₁^{t=1},E₁^{t=1}, . . . ,Eₙ₋₁^{t=1},Eₙ^{t=1}]

Output matrixes of the energy storage systems at the moments t=2, t=3, . . . , t=23 and t=24 are calculated according to the above steps, to obtain operation state data matrixes of the energy storage systems:

$${E}_{RANK}^{T} = [ \begin{matrix}{E}_{1}^{t = 1} & {E}_{2}^{t = 1} & … & {E}_{n}^{t = 1} \\ {E}_{1}^{t = 2} & {E}_{2}^{t = 2} & … & {E}_{n}^{t = 2} \\ … & … & … & … \\ {E}_{1}^{t = 24} & {E}_{2}^{t = 24} & … & {E}_{n}^{t = 24}\end{matrix} ]$$

The fees of the energy storage systems comprise two parts: the capacity fee and the kilowatt-hour fee. The capacity fee is used for compensating the opportunity cost generated as the energy storage systems participate in regulation, and the kilowatt-hour fee is used for compensating the loss generated as the energy storage systems are used; and a calculation method for the total use cost of the energy storage systems is shown as follows:

C_{ESN}=γR_{VOL}^{RANK}+P_{SS}_{ₙ}^{j}G_{ESN}

wherein in the formula, C_{ESN} represents the use cost of the energy storage systems; γ and P_{SS}_{ₙ}^{j} respectively represent price coefficients of the capacity right and the kilowatt-hour right of the energy storage systems; R_{VOL}^{RANK} represents the total capacity of the called energy storage systems; and G_{ESN} represents the total output value of the energy storage systems;

the capacity fee is allocated by all benefit subjects according to benefit proportions, following the formula below:

$${C}_{VOL}^{n} = γ {R}_{VOL}^{RANK} * \frac{{π}_{n}}{\sum π}$$

in the formula, C_{VOL}ⁿ represents the energy storage capacity fee allocated to a subject n; πₙ represents a benefit obtained by the subject n; and Σπ represents the total benefit obtained by the subjects participating in the trading except for the energy storage, comprising benefits of the clean energy power generation companies and benefits of the users.

The kilowatt-hour fee is used for compensating the actual output of the energy storage systems, and therefore, the kilowatt-hour fee is charged according to the principle that the fee is charged by a party who utilizes the power. When the kilowatt-hour fee is calculated, the variable output value of each called energy storage system at each moment is calculated firstly, following the formula below:

$${VE}_{RANK}^{T} = [ \begin{matrix}{E}_{1}^{t = 1} - 0 & {E}_{2}^{t = 1} - 0 & … & {E}_{n}^{T = 1} - 0 \\ {E}_{1}^{t = 2} - {E}_{1}^{t = 1} & {E}_{2}^{t = 2} - {E}_{2}^{t = 1} & … & {E}_{n}^{t = 2} - {E}_{n}^{t = 1} \\ {E}_{1}^{t = 3} - {E}_{1}^{t = 2} & {E}_{2}^{t = 3} - {E}_{2}^{t = 2} & … & {E}_{n}^{t = 3} - {E}_{n}^{t = 2} \\ … & … & … & … \\ {E}_{1}^{t = 24} - {E}_{1}^{t = 23} & {E}_{2}^{t = 24} - {E}_{2}^{t = 23} & … & {E}_{n}^{t = 24} - {E}_{n}^{t = 23}\end{matrix} ]$$

in the formula, each parameter in the matrix represents the variable output value of the energy storage system at each moment; the value represents the output variation of the energy storage system at each moment through comparison with the output value at the last moment and is a settlement basis of the kilowatt-hour fee.

Next, the total kilowatt-hour fee of all the moments is calculated, following the formula below:

$${C}_{CAPA}^{T} = [ \begin{matrix}{}^{t = 1} \sum {P}_{{SS}_{n}}^{j} * \vert {VE}_{RANK}^{t = 1} \vert \\ {}^{t = 2} \sum {P}_{{SS}_{n}}^{j} * \vert {VE}_{RANK}^{t = 2} \vert \\ … \\ {}^{t = 24} \sum {P}_{{SS}_{n}}^{j} * \vert {VE}_{RANK}^{t = 24} \vert\end{matrix} ]$$

Finally, the kilowatt-hour fee of each moment is allocated between the clean energy power generation company and the user according to the principle that the fee is charged by a party who utilizes the power. When the energy storage system is charged, the kilowatt-hour fee is borne by the clean energy power generation company; when the energy storage system is discharged, the kilowatt-hour fee is borne by the user; the kilowatt-hour fee of the clean energy power generation company is allocated according to the storage proportion; and the kilowatt-hour fee of the user is allocated according to the proportion of the total power consumption of all the moments in the power consumption of all the users, following the formulas below:

$${C}_{CAPA}^{T} ( solar ) = {}^{t = 1} \sum {P}_{{SS}_{n}}^{j} * \vert {VE}_{RANK}^{t = 1} \vert * \frac{{E}_{solar}^{t = 1}}{\sum {E}_{STORAGE}^{t = 1}} + {}^{t = 2} \sum {P}_{{SS}_{n}}^{j} * \vert {VE}_{RANK}^{t = 2} \vert * \frac{{E}_{solar}^{t = 2}}{\sum {E}_{STORAGE}^{t = 2}} + … + {}^{t = 24} \sum {P}_{{SS}_{n}}^{j} * \vert {VE}_{RANK}^{t = 24} \vert * \frac{{E}_{solar}^{t = 24}}{\sum {E}_{STORAGE}^{t = 24}}$$

$${C}_{CAPA}^{T} ( wind ) = {}^{t = 1} \sum {P}_{{SS}_{n}}^{j} * \vert {VE}_{RANK}^{t = 1} \vert * \frac{{E}_{wind}^{t = 1}}{\sum {E}_{STORAGE}^{t = 1}} + {}^{t = 2} \sum {P}_{{SS}_{n}}^{j} * \vert {VE}_{RANK}^{t = 2} \vert * \frac{{E}_{wind}^{t = 2}}{\sum {E}_{STORAGE}^{t = 2}} + … + {}^{t = 24} \sum {P}_{{SS}_{n}}^{j} * \vert {VE}_{RANK}^{t = 24} \vert * \frac{{E}_{wind}^{t = 24}}{\sum {E}_{STORAGE}^{t = 24}}$$

$${C}_{CAPA}^{T} ( u ( n ) ) = {}^{t = 1} \sum {P}_{{SS}_{n}}^{j} * \vert {VE}_{RANK}^{t = 1} \vert * \frac{{E}_{u ( n )}^{t = 1}}{{\sum }_{USERS}^{t = 1}} + {}^{t = 2} \sum {P}_{{SS}_{n}}^{j} * \vert {VE}_{RANK}^{t = 2} \vert * \frac{{E}_{u ( n )}^{t = 2}}{\sum {E}_{USERS}^{t = 2}} + … + {}^{t = 24} \sum {P}_{{SS}_{n}}^{j} * \vert {VE}_{RANK}^{t = 24} \vert * \frac{{E}_{u ( n )}^{t = 24}}{\sum {E}_{USERS}^{t = 24}}$$

After the decomposition of the consumed power and the allocation of the energy storage service fees are completed, the income of the clean energy power generation companies, the income of energy storage and the cost of the users can be obtained through calculation. The net income of the clean energy is the power generation income, from which the energy storage service fees are deducted; the net income of the energy storage is the sum of the capacity fee income and the kilowatt-hour fee income; and the power utilization cost of the users is the sum of the consumption fees of various types of clean energy, and the income thereof is the saved power utilization cost after the users participate in consumption.

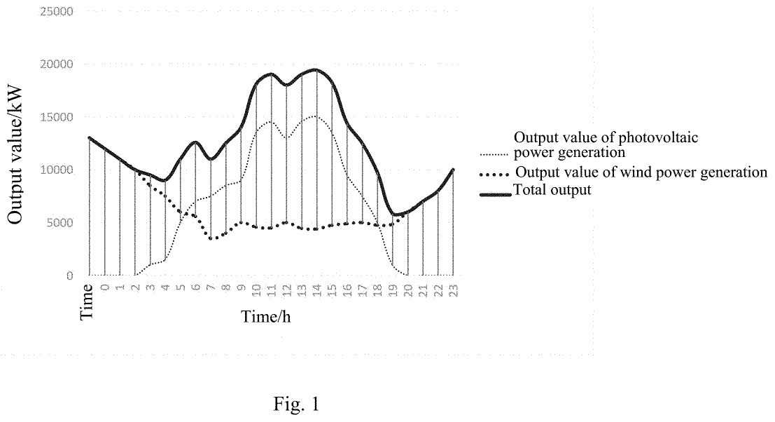

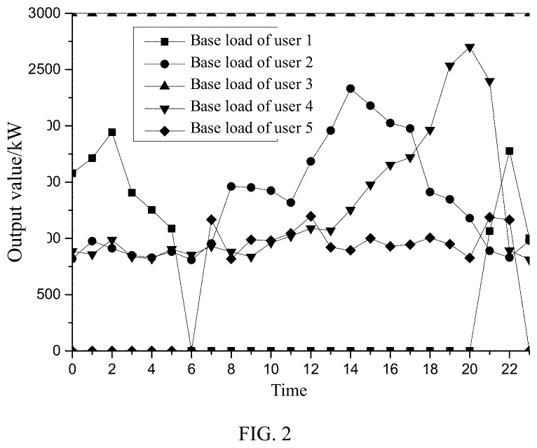

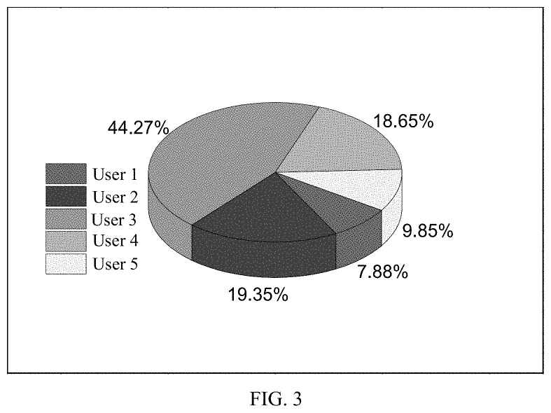

As an example, in the embodiment, an actual condition of a certain province is taken as an example, and an optimized clearing process for collaboratively consuming clean energy through demand-side resources and shared energy storage is simulated. It is assumed that two clean energy power generation companies participate in trading, A is a photovoltaic power generation enterprise, and B is a wind power generation enterprise; ten suppliers participate in bidding for an energy storage service; and six users participate in the trading, comprising a farmers market, an office building of a certain company, a cotton factory, a shopping mall, a school and an electric vehicle station axis center. In order to simplify calculation, curves of power generation of the clean energy and curves of loads of the users are not predicted in the embodiment, and prediction curves are directly given, which are respectively shown in FIG. 1, FIG. 2 and FIG. 3; and a tariff 1 of the province is shown as follows:

TABLE 1
Tariff of Users

| | User | User | User | User | User | Electric |
|---|---|---|---|---|---|---|
| Users | 1 | 2 | 3 | 4 | 5 | vehicle |
| Tariff | 0.5090 | 0.6664 | 0.6664 | 0.6664 | 0.8183 | 0.8283 |
| (Yuan/kWh) | | | | | | |

Main response resources of the users participating in collaborative trading comprise air conditioners and an electric vehicle, and investigations for the upper limit and the lower limit of the loads, adjustable time and adjustable duration are shown in Tab. 2.

TABLE 2
Analysis Table of Demand-Side Resources

| | Air | Air | Air | Air | Air | |
|---|---|---|---|---|---|---|
| Demand-side | conditioner | conditioner | conditioner | conditioner | conditioner | Electric |
| resources | 1 | 2 | 3 | 4 | 5 | vehicle |
| Upper limit | 800 | 2500 | 1500 | 2800 | 800 | 500 |
| of loads (kW) | | | | | | |
| Lower limit | 1500 | 2800 | 1800 | 3000 | 1200 | 500 |
| of loads (kW) | | | | | | |
| Adjustable | 21:00-5:00 | 8:00-20:00 | 00:00-23:59 | 11:00-21:00 | 7:00-22:00 | 00:00-23:59 |
| time | of a next | | | | | |
| | day | | | | | |
| Adjustable | 9 | 13 | 24 | 11 | 16 | 24 |
| duration (h) | | | | | | |

Bilateral Trading Results of the Clean Energy Power Generation Companies and the Users:

TABLE 2
Price Table of Bilateral Negotiated Trading

| | User | User | User | User | User | Electric |
|---|---|---|---|---|---|---|
| | 1 | 2 | 3 | 4 | 5 | vehicle |
| Photovoltaic | 0.3541 | 0.5462 | 0.4365 | 0.5223 | 0.3427 | 0.4357 |
| power | | | | | | |
| generation | | | | | | |
| (Yuan/kWh) | | | | | | |
| Wind power | 0.3505 | 0.5245 | 0.3438 | 0.5109 | 0.2998 | 0.3897 |
| generation | | | | | | |
| (Yuan/kWh) | | | | | | |

Bidding Results of the Energy Storage Service:

TABLE 3
Table of Bidding Results of Energy Storage Service

| No. of | | | Historical | | |
|---|---|---|---|---|---|
| energy | Capacity | Price | response | Ranking | |
| storage | (kW) | (Yuan/kWh) | index | index | Ranking |
| 1 | 1000 | 0.140 | 0.80 | 5714.29 | 10 |
| 2 | 5000 | 0.176 | 0.99 | 28125.00 | 5 |
| 3 | 7000 | 0.042 | 0.90 | 150000.00 | 1 |
| 4 | 1000 | 0.102 | 0.64 | 6274.51 | 9 |
| 5 | 1000 | 0.114 | 0.90 | 7894.74 | 8 |
| 6 | 4000 | 0.078 | 0.63 | 32307.69 | 4 |
| 7 | 2800 | 0.184 | 0.85 | 12934.78 | 7 |
| 8 | 4000 | 0.165 | 0.77 | 18666.67 | 6 |
| 9 | 5200 | 0.084 | 0.94 | 58190.48 | 2 |
| 10 | 6000 | 0.121 | 0.84 | 41652.89 | 3 |

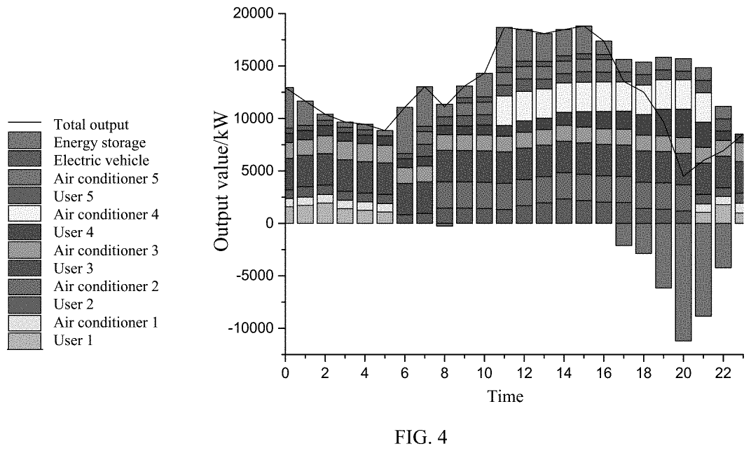

The optimized clearing results of systems for collaborative consumption are shown in FIG. 4;

Power Decomposition Data:

TABLE 4
Summary Data Table of Decomposition of Consumed Power of All Users

| | | | | | |
|---|---|---|---|---|---|
| Total Power | 297120 | Photovoltaic power | 148560 | Wind power | 148560 |
| Generation Capacity | | generation | | generation | |
| Total power | 20128 | Photovoltaic power | 1379 | Wind power | 18749 |
| consumption of user 1 | | generation of user 1 | | generation of user 1 | |
| Total power | 63974 | Photovoltaic power | 39009 | Wind power | 24965 |
| consumption of user 2 | | generation of user 2 | | generation of user 2 | |
| Total power | 109168 | Photovoltaic power | 46545 | Wind power | 62623 |
| consumption of user 3 | | generation of user 3 | | generation of user 3 | |
| Total power | 61133 | Photovoltaic power | 36652 | Wind power | 24481 |
| consumption of user 4 | | generation of user 4 | | generation of user 4 | |
| Total power | 35217 | Photovoltaic power | 21772 | Wind power | 13445 |
| consumption of user 5 | | generation of user 5 | | generation of user 5 | |
| Total power | 7500 | Photovoltaic power | 3202 | Wind power | 4298 |
| consumption of | | generation of electric | | generation of | |
| electric vehicle | | vehicle | | electric vehicle | |

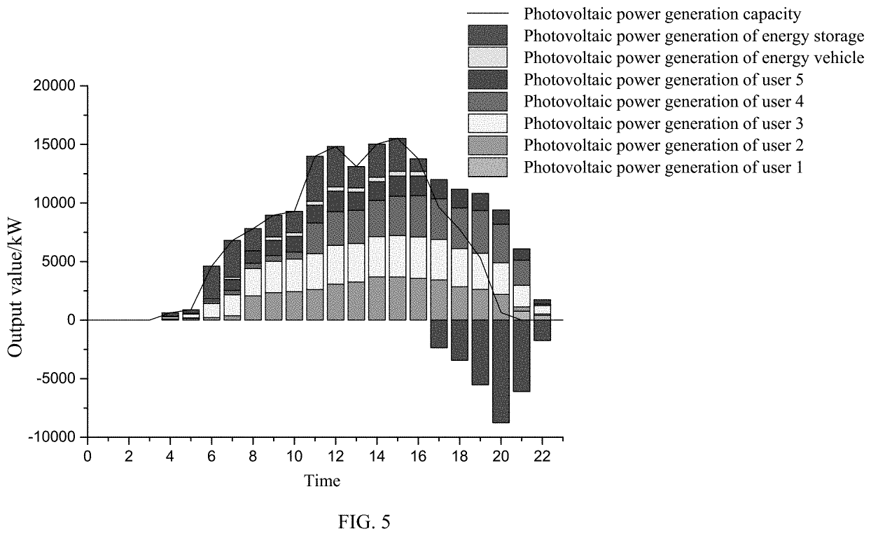

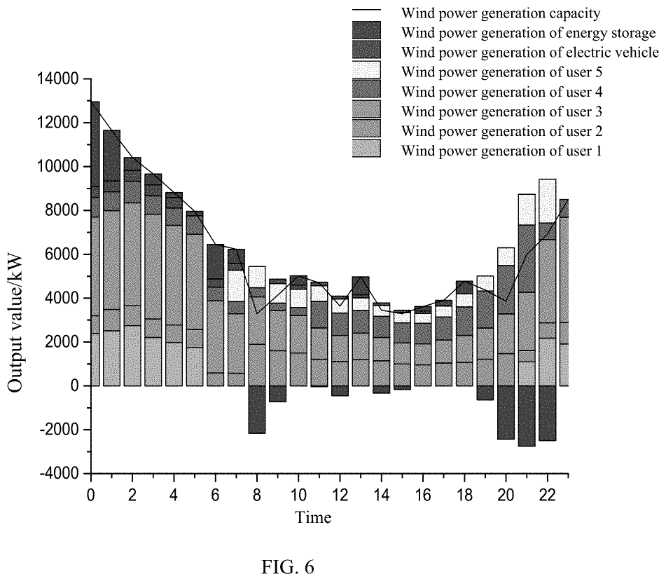

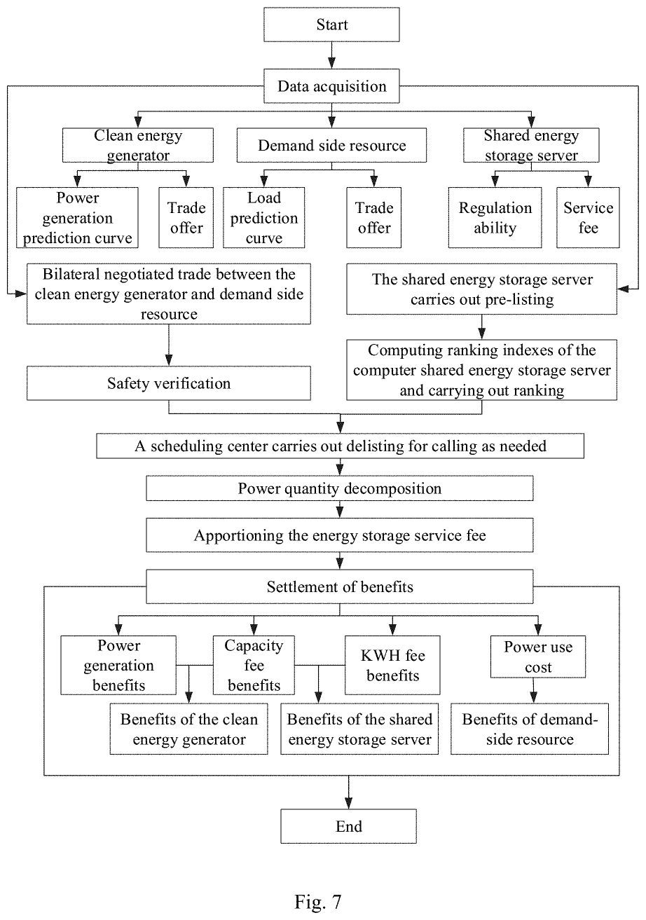

Schematic diagrams of consumed power of wind power generation and photovoltaic power generation of various types of power utilization subjects are obtained based on power decomposition data, which are specifically shown in FIG. 5, FIG. 6 and FIG. 7.

Income Analysis:

TABLE 5
Summary Table of Total Income

| Index | Unit | Summation |
|---|---|---|
| Total consumed power | kWh | 297120 |
| Total fee | Yuan | 129618.17 |
| Original fee | Yuan | 201748.50 |
| Saved expenditure | Yuan | 72130.33 |
| Capacity fee | Yuan | 37000 |
| Kilowatt-hour fee | Yuan | 8026.84 |
| Energy storage fee | Yuan | 45026.84 |

TABLE 6
Summary Table of Income of Power Generation Subjects of Clean Energy

| Index | Unit | Summation |
|---|---|---|
| Consumed power of photovoltaic power generation | kWh | 148560 |
| Consumed power of wind power generation | kWh | 148560 |
| Income of photovoltaic power generation | Yuan | 70210.11 |
| Income of wind power generation | Yuan | 59408.06 |

TABLE 7
Analysis Summary Table of Income of Users

| | | User | User | User | User | User | Electric |
|---|---|---|---|---|---|---|---|
| Index | Unit | 1 | 2 | 3 | 4 | 5 | vehicle |
| Total consumed | kWh | 20128 | 63974 | 109168 | 61133 | 35217 | 7500 |
| power | | | | | | | |
| Consumed power | kWh | 1379 | 39009 | 46545 | 36652 | 21772 | 3202 |
| of photovoltaic | | | | | | | |
| power generation | | | | | | | |
| Consumed power | kWh | 18749 | 24965 | 62623 | 24481 | 13445 | 4298 |
| of wind power | | | | | | | |
| generation | | | | | | | |
| Fee of | Yuan | 488.32 | 21306.96 | 20316.98 | 19143.50 | 7559.25 | 1395.10 |
| photovoltaic | | | | | | | |
| power generation | | | | | | | |
| Fee of wind | Yuan | 6571.51 | 13093.90 | 21529.72 | 12507.19 | 4030.80 | 1674.94 |
| power generation | | | | | | | |
| Total fee | Yuan | 7059.83 | 34400.87 | 41846.70 | 31650.69 | 11590.05 | 3070.04 |
| Tariff | Yuan/kWh | 0.5090 | 0.6664 | 0.6664 | 0.6664 | 0.8283 | 0.8283 |
| Original Fee | Yuan | 10245.15 | 42632.27 | 72749.56 | 40739.03 | 29170.24 | 6212.25 |
| Saved | Yuan | 3185.32 | 8231.41 | 30902.86 | 9088.35 | 17580.19 | 3142.21 |
| expenditure | | | | | | | |

TABLE 8
Analysis Table of Income of All Energy Storage Service Providers

| Ranking | | | | | | |
|---|---|---|---|---|---|---|
| (No.) of | | | | | | |
| energy | | Quotation of | Compensation | | | |
| storage | | kilowatt-hour | coefficient of | Income of | Income of | Total |
| service | Capacity | fee (Yuan/ | capacity fee | capacity | kilowatt-hour | income |
| providers | (kW) | kWh) | (Yuan/kWh) | fee (Yuan) | fee (Yuan) | (Yuan) |
| 1 (1) | 7000 | 0.042 | 1 | 7000 | 588.00 | 7588.00 |
| 2 (9) | 5200 | 0.084 | 1 | 5200 | 873.60 | 6073.60 |
| 3 (10) | 6000 | 0.121 | 1 | 6000 | 1514.92 | 7514.92 |
| 4 (6) | 4000 | 0.078 | 1 | 4000 | 624.00 | 4624.00 |
| 5 (2) | 5000 | 0.176 | 1 | 5000 | 1760.00 | 6760.00 |
| 6 (8) | 4000 | 0.165 | 1 | 4000 | 1320.00 | 5320.00 |
| 7 (7) | 2800 | 0.184 | 1 | 2800 | 1030.40 | 3830.40 |
| 8 (5) | 1000 | 0.114 | 1 | 1000 | 228.00 | 1228.00 |
| 9 (4) | 1000 | 0.102 | 1 | 1000 | 87.92 | 1087.92 |
| 10 (1) | 1000 | 0.140 | 1 | 1000 | 0.00 | 1000.00 |

TABLE 9
Analysis Table of Net Income

| | | Total fee | |
|---|---|---|---|
| | | of energy | |
| | Income | storage | Netincome |
| Subject | (Yuan) | (Yuan) | (Yuan) |
| Photovoltaic power | 70210.11 | 16119.41 | 54090.70 |
| generation | | | |
| Wind power generation | 59408.06 | 11665.55 | 47742.51 |
| User 1 | 3185.32 | 708.09 | 2477.23 |
| User 2 | 8231.41 | 2344.09 | 5887.32 |
| User 3 | 30902.86 | 6853.69 | 24049.17 |
| User 4 | 9088.35 | 2963.78 | 6124.57 |
| User 5 | 17580.19 | 3795.96 | 13784.23 |
| Electric vehicle | 3142.21 | 576.27 | 2565.94 |
| Summation | 201748.51 | 45026.84 | 156721.67 |

Finally, it needs to be noted that: the above embodiments are only used for describing the technical solutions of the present invention, rather than limiting the present invention. Although the present invention is described in detail with reference to the above embodiments, those ordinary skilled in the art should understand that: the technical solutions recorded in all the above embodiments can still be modified, or part of technical features therein can still be equivalently replaced; and these modifications or replacements do not enable the essence of the corresponding technical solutions to depart form the spirit and scope of the technical solutions of all the embodiments of the present invention.

We claim:

1. A collaborative aggregation trading method for consuming clean energy through demand-side resources and shared energy storage, comprising the following steps:
acquiring related data of clean energy power generation companies, demand-side resources and energy storage service providers, wherein the related data comprises prediction curves of power generation of the clean energy power generation companies, prediction curves of loads of the demand-side resources, as well as regulating ability data and service fee data of the energy storage service providers;
acquiring a trading quotation which is negotiated by the clean energy power generation companies and demand-side users and acquiring self-regulating ability data and regulating fees of shared energy storage service providers;
carrying out trading of collaboratively consuming the clean energy through the demand-side resources and the shared energy storage: when a power generation output value exceeds the maximum regulating ability of user demands and the demand-side resources, storing the redundant power into shared energy storage systems for standby application; and when the power generation output value is lower than the minimum operation load level of the user demands and the demand-side resources, calling the shared energy storage service providers participating in the trading according to energy storage ranking indexes, to acquire required power from the shared energy storage systems;
carrying out fees settlement on the trading to respectively acquire total income of the clean energy power generation companies, total income of the energy storage service providers and total income of the demand-side users.

2. The collaborative aggregation trading method for consuming clean energy through demand-side resources and shared energy storage according to claim 1, wherein the energy storage ranking index is:
$${RANK}_{{SS}_{n}}^{j} = \frac{{Vol}_{{SS}_{n}}^{j} * {res}_{{SS}_{n}}^{t - 1}}{{P}_{{SS}_{n}}^{j}} \times RANK ( {T}_{{SS}_{n}}^{j} )$$
wherein RANK_{SS}_{ₙ}^{j} represents a ranking index of an energy storage service provider SSₙ in a j^{th} quotation, and Vol_{SS}_{ₙ}^{j} represents the regulating ability thereof; res_{SS}_{ₙ}^{t-1} represents a historical response level, and the performance of the historical level of the energy storage service provider is comprehensively scored to obtain the value of [0, 1]; P_{SS}_{ₙ}^{j} represents service price thereof; and RANK(T_{SS}_{ₙ}^{j}) represents ranking of declaration time.

3. The collaborative aggregation trading method for consuming clean energy through demand-side resources and shared energy storage according to claim 2, wherein a method of carrying out fees settlement on the trading to respectively obtain the total income of the clean energy power generation companies, the total income of the energy storage service providers and the total income of the demand-side users is: net income of the clean energy power generation companies is the power generation income, from which energy storage service fees are deducted; net income of the energy storage service providers is the sum of capacity fee income and kilowatt-hour fee income; and the power utilization cost of the demand-side users is the sum of consumption fees of various types of clean energy, and the income thereof is the saved power utilization cost after the demand-side users participate in consumption.

4. The collaborative aggregation trading method for consuming clean energy through demand-side resources and shared energy storage according to claim 3, wherein the energy storage service fees comprise a capacity fee and a kilowatt-hour fee; the capacity fee is used for compensating the opportunity cost generated as the energy storage systems participate in regulation, and the kilowatt-hour fee is used for compensating the loss generated as the energy storage systems are used; and the energy storage service fees are borne jointly by the clean energy power generation companies and the demand-side users.

5. The collaborative aggregation trading method for consuming clean energy through demand-side resources and shared energy storage according to claim 3, wherein a method of acquiring the consumed power of various types of clean energy of the demand-side users comprises: decomposing the consumed power of various types of clean energy according to power system supply states of the total power consumption and power utilization moments of each user after an overall optimization result of the system is obtained, to obtain the total consumed power of photovoltaic power generation and the total consumed power of wind power generation of the demand-side users.

6. The collaborative aggregation trading method for consuming clean energy through demand-side resources and shared energy storage according to claim 4, wherein a method of acquiring the kilowatt-hour fee comprises:
acquiring a variable output value of each called energy storage service provider at each moment and obtaining the total kilowatt-hour fee of each moment; and allocating the kilowatt-hour fee of each moment between each clean energy power generation company and the user: wherein when the energy storage system is charged, the kilowatt-hour fee is borne by the clean energy power generation company; when the energy storage system is discharged, the kilowatt-hour fee is borne by the user; the kilowatt-hour fee of the clean energy power generation company is allocated according to a storage proportion; and the kilowatt-hour fee of the user is allocated according to a proportion of the total power consumption of all the moments in the power consumption of all the users.

7. The collaborative aggregation trading method for consuming clean energy through demand-side resources and shared energy storage according to claim 3, wherein a method of acquiring the output value of each called energy storage service provider at each moment comprises:
1) judging whether E_{STORAGE}^{t=1}>R_{VOL}¹ is true or not, wherein E_{STORAGE}^{t=1} represents an energy storage demand of the system at the moment t=1, and R_{VOL}¹ represents the capacity of the system of a called energy storage service provider No. 1;
a, if yes, systems of the remaining energy storage service providers need to be called continuously;
b, if no, remaining energy storage systems do not need to be called continuously;
2) acquiring an actual load state of the called energy storage service provider No. 1:
a, if 1) is true, E₁^{t=1}=R_{VOL}¹ i.e., the actual load of a called energy storage system No. 1 is the capacity thereof at the moment t=1, and namely, the system operates at full load;
b, if 1) is not true, E₁^{t=1}=E_{STORAGE}^{t=1} i.e., the actual load of the called energy storage system No. 1 is the energy storage demand of the system at the moment t=1, and namely, the system operates at a load of the energy storage demand;
3) acquiring the capacity of the system of the energy storage service provider, which needs to be called continuously at the moment t=1:
when 1) is true, the called energy storage system No. 1 operates at full load, which still cannot meet the energy storage demand of the system; the remaining energy storage systems need to be called continuously; and the capacity of the energy storage system which needs to be called continuously at the moment t=1 is:
E_{STORAGE}^{t=1}(−1)=E_{STORAGE}^{t=1}−R_{VOL}¹
in the formula, E_{STORAGE}^{t=1} (−1) represents the remaining demand after the energy storage system is called once at the moment t=1;
4) judging whether E_{STORAGE}^{t=1}(−1)>R_{VOL}² is true or not:
a, if yes, the remaining energy storage demand of the system at the moment t=1 is greater than the capacity of a called energy storage system No. 2, and the remaining energy storage systems need to be called continuously;
b, if no, the remaining energy storage demand of the system at the moment t=1 is less than the capacity of the called energy storage system No. 2, and the remaining energy storage systems do not need to be called continuously;
5) acquiring an actual load state of the called energy storage system No. 2, which is the same as step 2);
6) acquiring the capacity of the energy storage system which needs to be called again at the moment t=1, which is the same as step 3);
circulating the above steps until the output demand which meets energy storage of the system at the moment t=1 is obtained.
